(19) United States
(12) Patent Application Publication
(10) Pub. No.: US 2009/0260717 A1
(43) Pub. Date: Oct. 22, 2009

(54) LOG DEBARKING APPARATUS

(75) Inventors: Richard L. McQueen, Mount Pleasant, MI (US); LaVern T. Sandborn, Mount Pleasant, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: MORBARK, INC., Winn, MI (US)

(21) Appl. No.: 12/106,551

(22) Filed: Apr. 21, 2008

(51) Int. Cl. B27L 1/00; B27G 13/00

(52) U.S. Cl. 144/208.1; 144/228

(57) ABSTRACT

A Rosserhead debarker having a cutter head with an improved cutter teeth mounting system. The cutter head drum defines a plurality of cutter tooth slots, each having a recess at its base. The cutter teeth are fitted into the slots with the base of each tooth closely received in the corresponding recess. A portion of each tooth protrudes from the slot to receive a blade. Each cutter tooth may be secured to the drum by a fastener extending in a generally radial direction. Each cutter tooth may include a removal stud that can be used to assist in removing the tooth from the drum. The cutter head may be mounted for axial deflection and may include a pivot yoke lock for selectively locking the cutter head against axial deflection. The pivot yoke lock facilitates certain operations where axial deflection may not be desired, including those in which only one end of the cutter head is riding on the log, such as during butt reducing. The cutter head may include a manually adjustable shoe disposed on the trailing side of the cutter head. The manually adjustable shoe may be used to limit the cutting depth of the cutter head even when only the trailing end of the cutter head is riding on the log.

### BACKGROUND OF THE INVENTION

The present invention relates to equipment for processing felled timber and more particularly to an apparatus for removing bark and other undesired material from logs.

When processing felled timber for use in the production of lumber, it is typically beneficial to remove bark, knots and other undesirable material from the log. A variety of machinery has been developed and is commercially available for carrying out the debarking process. Although the removal of bark, knots and other irregularities from a log is beneficial, it is typically desirable not to remove any more material from the log than necessary. If too much material is removed, it can, among other things, have a negative impact on the lumber produced from the log. For example, cutting away even a small portion of the diameter of the log can reduce the overall volume of lumber and the size of the lumber that can be produced from the log. This can significantly reduce the revenue generated by the log. Accordingly, it is desirable to provide a machine that provides quick and easy removal of bark and other undesirable material from the log, while, at the same time, avoids excessive removal of material.

One particularly effective type of debarking machinery is known as a Rosserhead debarker. Rosserhead debarkers generally include a log turning assembly for supporting and turning a log and a debarker cutter head with cutter teeth for removing material from the log as it is being rotated by the log turning assembly. The debarker cutter head is rotated at a relatively high rate of speed so that the cutter teeth are capable of removing material from the log upon contact. The debarker cutter head is typically supported on a carriage that permits the cutter head to move longitudinally along the length of the turning log so that the cutter head can debark the entire length of the log. In a typical Rosserhead debarker, the debarker cutter head is carried on a pivot arm that allows the debarker cutter head to move laterally with respect to the length of the log to accommodate irregularities in the log, such as bends, knots and variations in thickness. The position of the debarker cutter head and the position of the cutter head pivot arm are often controlled by an operator using powered drive systems. For example, the carriage may be moved along the length of the log using a chain drive system. Similarly, the position and down-pressure of the cutter head pivot arm may be controlled by hydraulics.

A number of commercially available Rosserhead debarkers include an axial deflection system that permits the debarker cutter head to pivot about an axis that extends substantially perpendicularly to the length of the log. As a result, the debarker cutter head can pivot during operation as the head travels over irregular portions of the log. For example, the debarker cutter head may deflect axially so that it remains more aligned with the engaged portion of the log. This can provide improved performance when operating over knots and bends, and when working a log with significant variation in diameter. Although axial deflection is beneficial much of the time, there are situations where axial deflection can be problematic. For example, axial pivoting of the debarker cutter head can make it difficult to focus the attention of the cutter head on a single irregularity, such as a knot. If the head is not centered properly on the knot, the cutter head may pivot off the knot making it more difficult to take down the knot without engaging adjacent portions of the log. As another example, with some equipment, the debarker cutter head has a tendency to deflect axially as the cutter head is moved off the end of the log. This axial deflection can have the affect of “rounding” the end of the log and reducing the effective diameter from the perspective of producing lumber.

Typical debarker cutter heads include teeth that are arranged around the cutter head drum in a spiraling offset pattern with the opposite edges of adjacent teeth being substantially aligned so that collectively the cutter teeth provide a continuous cutting swath across the head without gaps. Over extended use, the cutter teeth have a tendency to wear. Wear on the side edges of the cutting teeth can reduce the teeth to the point where they no longer provide a continuous cutting swath. Rather, small gaps can develop between the cutter teeth. These gaps can reduce the performance of the debarker and can produce an undesirable texture of the debarked log.

As cutter teeth wear over time, they ultimately require replacement. Experience has revealed that it can be difficult to replace cutter teeth with many existing cutter teeth arrangements. In some cases, the cutter teeth are difficult to replace because the cutter teeth fasteners become corroded. Given that debarking machinery is often used in an outside environment, it is not uncommon for fasteners to be subjected to environmental conditions that lead to corrosion. In other cases, the cutter teeth may become wedged within the cutter head. For example, over-tightening of the cutter teeth fasteners can cause the cutter teeth to deform and become wedge within the cutter head bores.

### SUMMARY OF THE INVENTION

The present invention provides a debarker cutter head with an improved cutter teeth mounting system. In one embodiment, the cutter head drum includes a plurality of cutter tooth slots, each configured to closely receive a corresponding cutter tooth. Each cutter tooth slot defines a mounting hole for securing a cutter tooth in the slot. Each cutter tooth includes a base and a finger. The cutter tooth base is fitted into a cutter tooth slot with the finger protruding outwardly to support a cutter blade. The cutter teeth and cutter tooth slots may be configured to position the cutter blades so that they extend substantially along a radius of the cutter head drum.

In one embodiment, the cutter tooth defines a first through hole to receive a fastener for securing the cutter tooth within the slot and a second hole to receive a removal stud for use in removing the cutter tooth. The stud through hole may be internally threaded to permit the stud to be threaded down onto bottom surface of the cutter tooth slot to drive the cutter tooth from the slot. The bolt through hole may be unthreaded, thereby allowing the mounting bolt to be freely threaded into the mounting hole in the bottom surface of the cutter tooth slot. If desired, the through holes may be counter bore to recess the stud and the head of a mounting bolt.

In one embodiment, the cutter tooth is generally L-shaped with the base forming one leg of the “L” and the finger forming the other. In this embodiment, the based may define the first and second through-holes. The top surface of the base may be curved to follow the shape of the cutter head drum.

In one embodiment, the cutter head slot is generally rectangular in cross-section. The cutter head slot may be defined by parallel leading and trailing surfaces that extend in a somewhat radial orientation. The bottom surface of the slot may be substantially planar and extend perpendicularly between the leading and trailing surfaces.

In one embodiment, at least some of the cutter teeth are configured and arranged on the cutter head drum to overlap in a circumferential direction. As a result, substantial wear on the side edges of the cutter teeth can occur without creating gaps in the cutting swath.

In another aspect, the present invention provides a debarker cutter head with axial deflection and a pivot lock to selectively lock the head against axial deflection. The pivot lock permits the operator to selectively secure the debarker cutter head in a single axial position, when desired.

In one embodiment, the pivot lock includes a locking pin that is selectively engaged with a receiver. The locking pin and receiver may include complementary cone-shaped engagement portions that permit the pivot lock to engage even when the debarker cutter head is axially deflected.

In another embodiment, the debarker cutter head includes a manually adjustable shoe that supports the trailing end of the debarker cutter head and prevents it from cutting too deeply into the log. The trailing shoe may include a replaceable wear insert.

The present invention provides meaningful improvements to debarker machinery. The cutter teeth mounting system provides a simple and effective mechanism for securing the cutter teeth. By closely fitting the base of the cutter teeth into the cutter tooth slots, the cutter teeth fasteners are not required to bear the load of the cutting operation. Rather, the cutter head drum retains the cutting teeth and bears the primary load. The depth of the recesses can be varied to provide the desired level of support for the cutter teeth. The removal studs facilitate removal of the cutter teeth for repair or replacement. The overlapping cutter teeth arrangement extends the life of the cutter teeth by allowing substantial side edge wear without creating gaps in the cutting swath. The pivot lock gives an operator the ability to lock the cutter head in a fixed axial position when desired. The locked cutter head facilitates certain debarking and log working operations, such as knot removal. The locked cutter head may be particularly useful in butt reducing operations, where the cutter head is working the end of a log with only one end riding on the log. The manually adjustable shoe provides even greater control over certain debarking operations. When the head pivot lock and manually adjustable shoe are used together, the debarker cutter head is particularly effective at operating on log ends, for example, when performing butt reduction operation. In these operations, the head pivot lock helps to reduce “rounding” of the log end and the trailing shoe helps to prevent excessive removal of material from the end of the log.

These and other objects, advantages, and features of the invention will be readily understood and appreciated by reference to the detailed description of the current embodiment and the drawings.

### BRIEF DESCRIPTION OF THE DRAWINGS

FIG. 1 is a perspective view of a Rosserhead debarker in accordance with an embodiment of the present invention.

FIG. 2 is an enlarged perspective view of a portion of the Rosserhead debarker showing the cutter arm assembly.

FIG. 3 is a sectional view of the Rosserhead debarker.

FIG. 4 is a rear perspective view of the cutter head arm.

FIG. 5 is a top plan view of the cutter head arm.

FIG. 6 is a front elevational view of the cutter head arm.

FIG. 7 is a side elevational view of the cutter head arm.

FIG. 8 is a perspective view of the cutter arm frame.

FIG. 9 is a top plan view of the cutter arm frame.

FIG. 10 is a perspective view of the yoke.

FIG. 11 is a top plan view of the yoke.

FIG. 12 is a perspective view of the cutter head.

FIG. 13 is a top plan view of the cutter head.

FIG. 14 is a side elevational view of the cutter head.

FIG. 15 is a sectional view of a portion of the cutter head showing a cutter head slot.

FIG. 16A is a side elevational view of a straight cutter tooth.

FIG. 16B is a top plan view of a straight cutter tooth.

FIG. 17 is a front elevational view of a straight cutter tooth.

FIG. 18 is a front elevational view of a left-hand cutter tooth.

FIG. 19 is a front elevational view of a right-hand cutter tooth.

FIG. 20 is a flat pattern representation of the cutter tooth arrangement on the cutter head.

FIG. 21A is a front elevational view of the cutter head arm used as a reference for FIG. 21B.

FIG. 21B is a sectional view of the cutter head arm taken along Line A-A of FIG. 21A.

FIG. 22A is a front elevational view of the cutter head arm used as a reference for FIG. 22B.

FIG. 22B is a sectional view of the cutter head arm taken along Line A-A of FIG. 22A.

FIG. 23 is a front elevational view of the main body of the manually adjustable shoe.

FIG. 24 is a side elevational view of the main body of the manually adjustable shoe.

FIG. 25 is a front elevational view of the wear insert.

FIG. 26 is a side elevational view of the wear insert.

FIG. 27A is a front elevational view of the cutter head arm used as a reference for FIG. 27B.

FIG. 27B is a sectional view of the cutter head arm taken along Line A-A of FIG. 27A showing the yoke pivot lock in the locked position.

FIG. 28A is a front elevational view of the cutter head arm used as a reference for FIG. 28B.

FIG. 28B is a sectional view of the cutter head arm taken along Line A-A of FIG. 28A showing the yoke pivot lock in the unlocked position.

FIG. 29 is a top plan view of the locking pin.

FIG. 30 is a perspective view of the guide.

FIG. 31 is a front elevational view of the guide.

FIG. 32 is a perspective view of the receiver.

FIG. 33 is a top plan view of the receiver.

### DESCRIPTION OF THE CURRENT EMBODIMENT

### I. Overview.

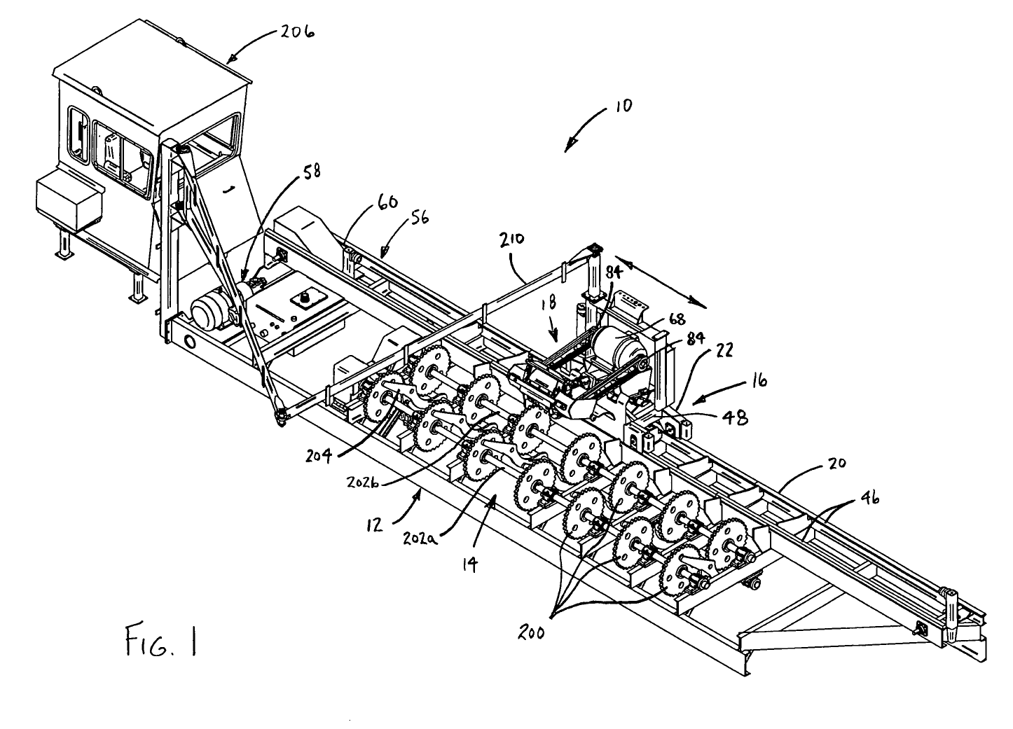

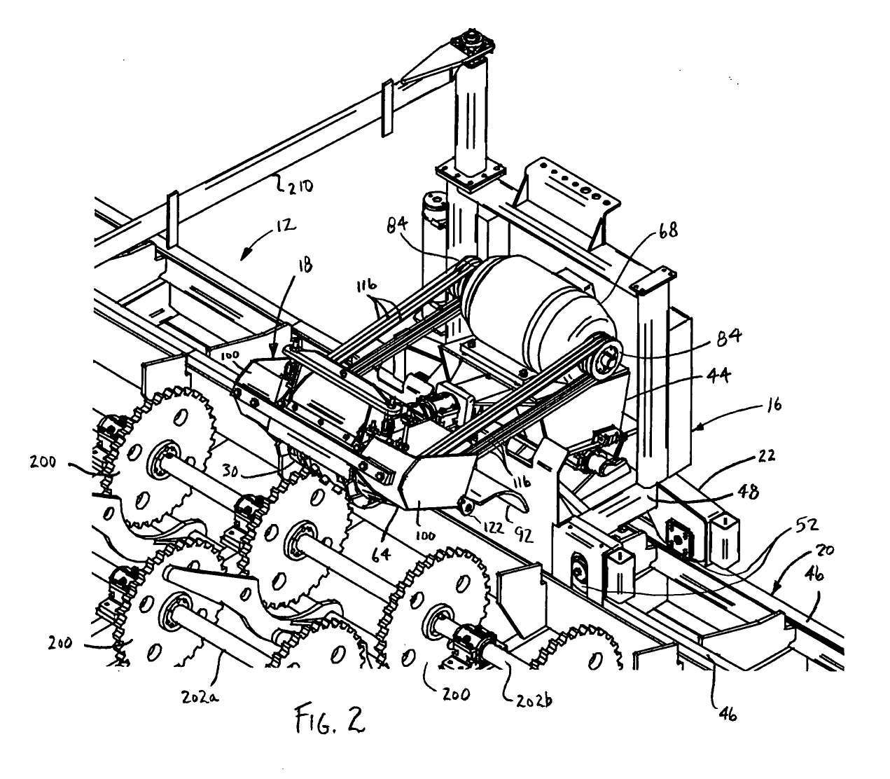

A Rosserhead debarker 10 in accordance with an embodiment of the present invention is shown in FIG. 1. The illustrated Rosserhead debarker 10 generally includes a superstructure 12, a log turning assembly 14, a carriage assembly 16, a cutter head arm 18 and an operator cab 100. The log turning assembly 14 is mounted on the superstructure 12 and provides a mechanism for turning a log to be worked. The carriage assembly 16 includes a track subassembly 20 supported on the superstructure 12 and a cutter arm carriage 22 mounted for linear movement along the track subassembly 20. The cutter head arm 18 is mounted to the carriage 22 so that it can be carried along the entire length of the log. The cutter head arm 18 includes a cutter head 30 and is pivotally mounted to the carriage 22 so that the cutter head 30 can be raised and lower onto a log (See FIG. 6, Line B). The cutter head 30 generally includes a drum 32 and a plurality of cutter teeth 34a-c. The drum 32 is rotated at a high rate of speed so that upon contact the cutter teeth 34a-c remove bark and other material from the log. The drum 32 defines a plurality of cutter tooth slots 36. Each cutter tooth 34a-c is mounted on the drum 32 with its base 40 fitted closely fitted into the slot 36 and its remaining length exposed. Bolts 42 or other fasteners extend through the base 40 into the drum 32 to secure each tooth 34a-c. The cutter head arm 18 generally includes a frame 44 mounted to the carriage 22 and a yoke 64 pivotally mounted to the frame 44. The yoke 44 carries the cutter head 30 and is configured to permit the cutter head 30 to deflect axially during operation (See FIG. 6, Line A). The frame 44 may include a yoke pivot lock 24 that permits the operator to selectively lock the yoke 64 against axial deflection. The locked yoke 64 provides an axially fixed cutter head that facilitates certain operations, such as butt reducing. The cutter head assembly 16 may also include an adjustable shoe 26 disposed on the trailing side of the cutter head 30. The adjustable shoe 26 may be set to control the cutting depth of the trailing end of the cutter head 30, which supports the cutter head 30 as it works the end of a log, for example, during butt reducing operations.

The illustrated embodiment shows the present invention incorporated into a Rosserhead debarker that is generally identical to the Morbark Model 648 Rosserhead Debarker, which is available from Morbark, Inc. of Winn, Mich. The illustrated debarker includes a variety of optional features and components that are not necessary for implementation of the present invention. The present invention is not limited to use on or in connection with this specific Rosserhead debarker. To the contrary, the various features and aspects of the present invention are well suited for incorporation into a wide variety of debarkers.

### II. General Structure.

As noted above, the Rosserhead debarker 10 of the illustrated embodiment includes a log turning assembly 14 that supports and turns the log to be worked. In the illustrated embodiment, the log turning assembly 14 is a generally conventional bull wheel assembly that is mounted to the superstructure 12. The debarker 10 may, however, incorporate essentially any log turning assembly. Because the log turning assembly 14 of the illustrated embodiment is generally conventional, it will not be described in great detail. Suffice it to say that the log turning assembly 14 generally includes a plurality of log rotation wheels 200 that operate in unison to support and turn the log. In the illustrated embodiment, the log rotation wheels 200 are arranged in six sets or pairs spaced along the length of the debarker 10. In the illustrated embodiment, the log rotation wheels 200 are carried on log rotation shafts 202a-b that are driven by a hydraulic motor (not shown). The hydraulic motor (not shown) is linked to conventional controls that permit an operator to control the speed and direction of rotation of the log rotation wheels 200. The log turning assembly 14 may include generally conventional log kicker arms 204 that move worked logs off of the log turning assembly 14. The log kicker arms 204 may be operated by hydraulics or other powered systems. Suitable log turning assemblies are available from Morbark, Inc. of Winn, Mich. For example, the present invention may incorporate the bull wheel assembly of the Morbark Model 648 Rosserhead Debarker.

The debarker 10 may be combined with a log infeed assembly (not shown) that delivers logs to the log turning assembly 14 and an outfeed assembly (not shown) that carries worked logs away from the debarker 10. The infeed and outfeed assemblies may be conventional system and therefore will not be described in detail. Suffice it to say that the log infeed assembly may be a conventional log deck that includes “stop and load” arms for indexing logs onto the log turning assembly 14, and the log outfeed assembly may be a conventional trough conveyor that receives log ejected from log turning assembly 14 by the kicker arms 204. Suitable log infeed and outfeed assemblies are commercially available from Morbark, Inc. of Winn, Mich.

Operation of the debarker 10, including control over operation of the log infeed assembly (not shown), the log turning assembly 14, the carriage 22, and the cutter head arm 18, is typically carried out by a single operator. To facilitate control, the illustrated debarker 10 includes an operator cab 206, where the various debarker controls (not shown) are housed. Although convenient, the cab 206 is optional and may be eliminated, if desired. An articulating boom 210 may be provided for routing hydraulic, electrical and other facilities from the cab 206 to the carriage assembly 16.

As noted above, the debarker 10 includes a carriage assembly 16 mounted to the superstructure 12 adjacent to the log turning assembly 14. The carriage assembly 16 generally includes a track 20 and a cutter arm carriage 22. The track 20 includes a pair of rails 46 that are fixed to the superstructure 12 to provide a track to guide back-and-forth movement of the cutter arm carriage 22 along the logs to be worked. In the illustrated embodiment, the rails 46 extend beyond the length of the log turning assembly 14. This permits the cutter head carriage 22 to move fully out of the way so that a worked log can be ejected from the log turning assembly 14 over the track 20. For example, a worked log may be ejected from the log turning assembly 14 to a trough conveyor or other log outfeed assembly positioned along the opposite side of the track 20.

The cutter arm carriage 22 is movably mounted to the track 20. The cutter arm carriage 22 carries the cutter head arm 18 so that the cutter head arm 18 can be selectively moved along the length of a log. The cutter arm carriage 22 generally includes a carriage frame 48 and a plurality of wheels 52. The wheels 52 are rotatably fixed to the carriage frame 48 to permit the carriage 22 to ride along the rails 46 in a generally conventional manner. The cutter arm carriage 22 of the illustrated embodiment also includes a mounting beam 54 (See FIG. 3) that is fixed to the carriage frame 48 to receive and pivotally support the cutter head arm 18. In the illustrated embodiment, the mounting beam 54 is circular in cross section providing a support about which the cutter head arm 18 may rotate.

The illustrated debarker 10 includes a drive mechanism 56 that permits an operator to selectively move the carriage 22 along the rails 46. The drive mechanism 56 may be a conventional hydraulic motor 58 that is coupled to the carriage 22 by a chain drive system 60. In embodiments using this type of drive mechanism, the chain drive system 60 is coupled to the carriage 22 and the hydraulic motor 58 is operatively coupled to the chain drive system 60. Accordingly, operation of the hydraulic motor 58 can be used to move the carriage 22 back and forth along the rails 46 via the chain drive system 60. The chain drive system 60 may be replaced by other systems capable of providing back-and-forth linear movement of the cutter arm carriage 22.

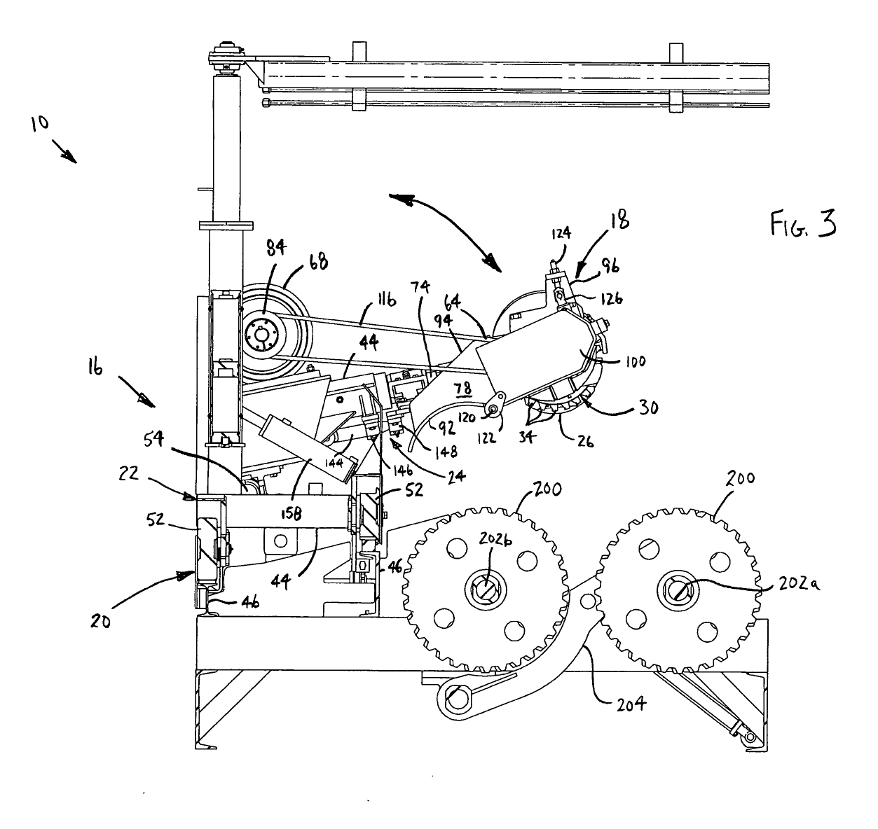

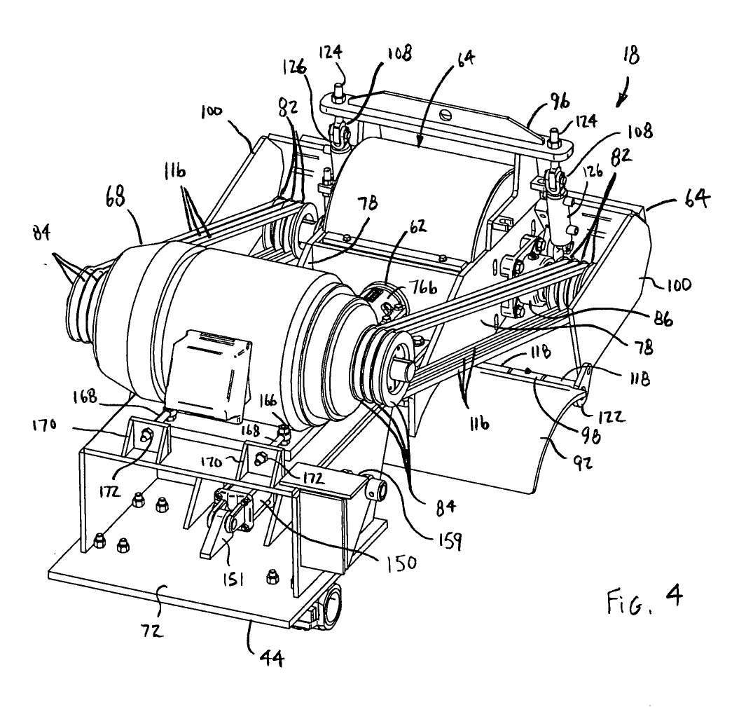

Referring now to FIGS. 4-7, the cutter head arm 18 carries the cutter head 30, and is mounted to the cutter arm carriage 22 so that it can be selectively moved along the full length of a log situated on the log turning assembly 14. The cutter head arm 18 is pivotally mounted to the carriage 22 so that the cutter head 30 can be selectively lowered into engagement with a log to be worked. The cutter head arm 18 generally includes a cutter arm frame 44, a yoke 64, a cutter head 30 and a cutter head drive motor 68. The cutter arm frame 44 is mounted to the carriage 22 and provides a structure for supporting the yoke 64 and the cutter head drive motor 68 (See also FIGS. 8 and 9). In the illustrated embodiment, the cutter arm frame 44 includes a base 72 that is pivotally mounted to the mounting beam 54 by a pair of bearings 70a-b (See FIG. 6). The bearings 70a-b may be essentially any suitable bearing, such as 2500 Series bearings available from Anson Industrial Mfg. Corporation. The bearings 70a-b permit the cutter head arm 18 to pivot up and down with respect to the carriage 22. Pivotal motion of the cutter head arm 18 may be controlled by a hydraulic cylinder 158 coupled between the carriage 22 and the cutter head arm 18 (See FIG. 3). The hydraulic cylinder 158 may be secured to the cutter arm frame 44 at mounting 159. The hydraulic cylinder 158 may be used to raise and lower the cutter head arm 18, and to provide a desired level of down-pressure on the cutter head 30 during use. The hydraulic cylinder 158 will typically have the ability to allow the cutter head arm 18 to operate in a “float” position, during which the cutter head arm 18 may ride along the contours of the log. In this position, the cutter head arm 18 may be held against the log solely by the weight of the cutter head arm 18, or it may be supplemented by additional down-pressure provided by the hydraulic cylinder 158.

As noted above, the drive motor 68 is mounted to the cutter arm frame 44 and is operatively coupled to the cutter head 30. The cutter head drive motor 68 may be a conventional electric motor, hydraulic motor or other suitable drive motor. In the illustrated embodiment, the drive motor 68 includes six drive wheels 84—three installed on each end of the output shaft (not numbered) of the motor 68. The motor drive wheels 84 are coupled to the belt wheels 82 on opposite ends of the cutter head axle 80 by belts 116. The cutter arm frame 44 includes a motor mount 162 that defines mounting slots 164. The motor 68 may be mounted to the motor mount 162 by bolts 166 fitted through the motor mounting plate (not numbered) and the mounting slots 164. To permit motor position adjustment (for example, to adjust belt tension), the rearmost bolts 166 may be attached to motor position brackets 170 by eyebolts 168. In this embodiment, the position of the motor 68 may be adjusted by varying the position of the eyebolts 168 with respect to the motor position brackets 170 using adjustment nuts 172. More specifically, movement of the adjustment nuts 170 causes the motor 68 to move along slots 164.

In the illustrated embodiment, the cutter arm frame 44 also support a yoke pivot lock 24 (described in more detail below). The illustrated cutter arm frame 44 includes a mounting ear 151 for the hydraulic cylinder 150 of the yoke pivot lock 24. The mounting ear 151 may be fixed to base 72, for example, by welding.

As noted above, the cutter arm frame 44 supports the yoke 64 and cutter head 30. To support the yoke 64, the illustrated cutter arm frame 44 includes a support arm 74 extending from the base 72. The illustrated support arm 74 is tubular in cross-section, but its configuration may vary from application to application depending, for example, on the pivot mechanism used to permit axial deflection of the yoke 64. The tubular shape of the support arm 74 provides a mounting structure around which the yoke 64 may pivot to provide the cutter head 30 with axial deflection. The support arm 74 may be fitted into a collar 43 and secured by bolts 45. A stop ring 62 may be fixed to the support arm 74 near its free end to lock the yoke bearings 72a-b on the support arm 74, as described in more detail below. The stop ring 62 may be welded or otherwise secured to the support arm 74.

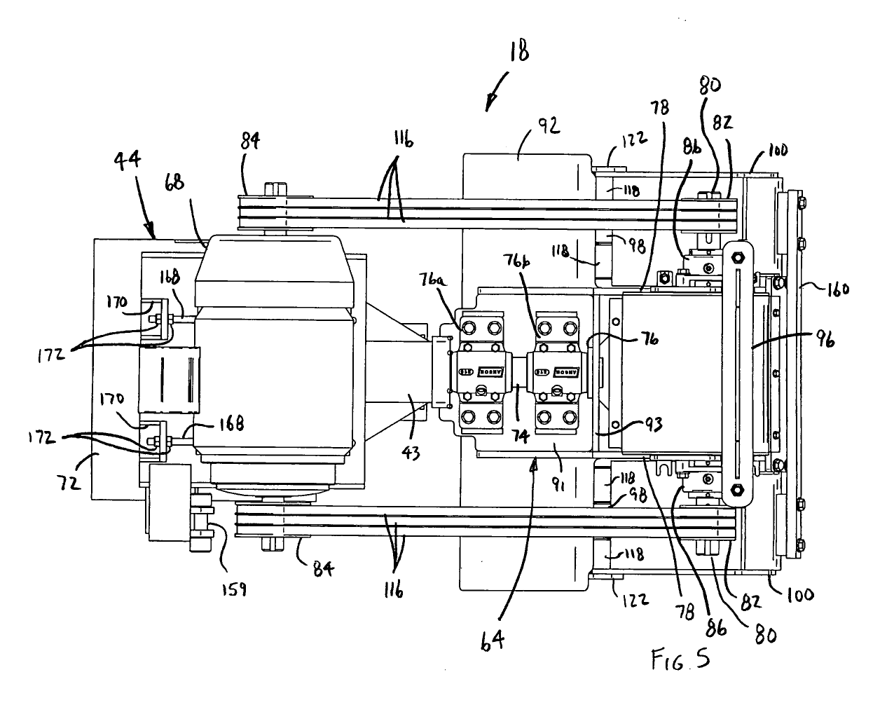

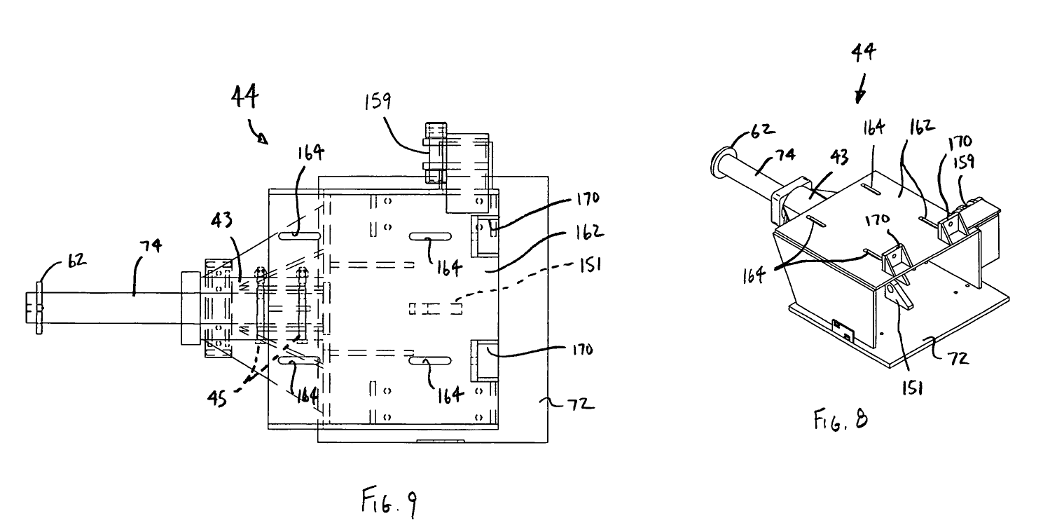

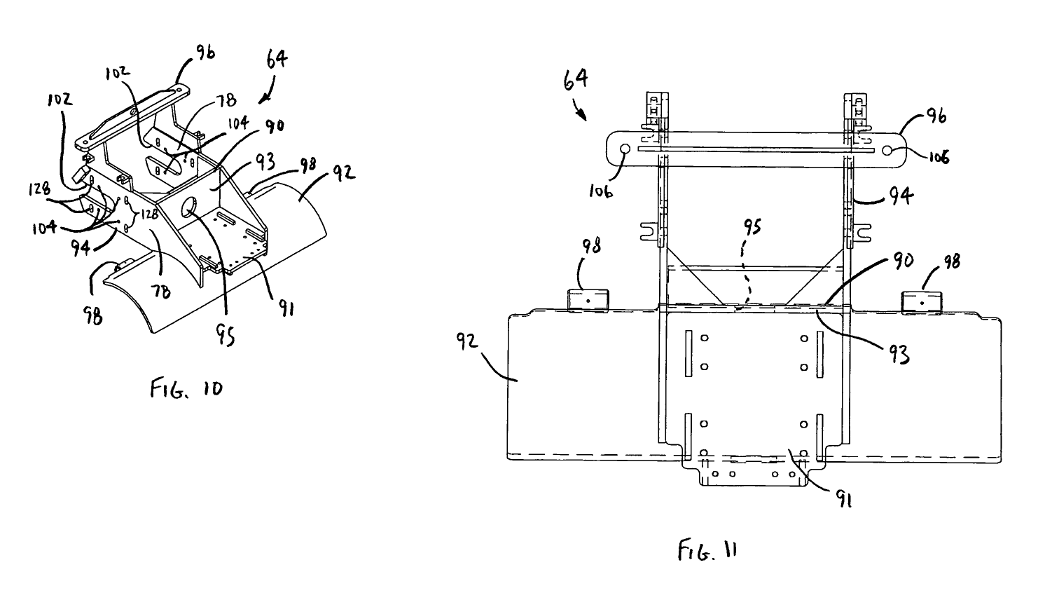

The yoke 64 pivotally couples the cutter head 30 to the cutter arm frame 44. The yoke 64 generally includes a mounting collar 90, a yoke shield 92, a cutter head subframe 94 and an outer shoe subframe 96 (See FIGS. 10 and 11). The mounting collar 90 includes a base 91 and an upright 93. The upright 93 defines a circular opening 95 that is fitted over the support arm 74. The mounting collar base 91 extends substantially parallel to the support arm 74 and is coupled to the support arm 74 by bearings 76a-b. The bearings 76a-b permit the yoke 64 to rotate about the support arm 74 and consequently provide the cutter head 30 with a range of axial deflection. As perhaps best shown in FIG. 5, the bearings 76a-b are positioned against the collar 43 and the stop ring 62 to resist linear movement of the yoke 64 along the support arm 74 in the axial direction. The yoke shield 92 is fixed to the mounting collar 90 and is shaped to shield against cutting debris. The yoke shield 92 includes right and left sleeves 98 that support the right and left outer shoes 100, as described in more detail below. The cutter head subframe 94 is fixed to the mounting collar 90 and includes a pair of spaced apart mounting walls 78 that are configured to receive and support opposite ends of the cutter head 30, as described in more detail below. Each mounting wall 78 defines a slot 102 to accommodate the cutter head axle 80, as well as a plurality of mounting holes 104 for securing cutter head axle support bearings 86 by bolts or other fasteners. The cutter head axle support bearings 86 entrap and rotatably support the cutter head axle 80, thereby securing the cutter head 30 to the cutter head subframe 94 while permitting the cutter head 30 to rotate freely. The outer shoe subframe 96 is mounted to the cutter head subframe 94 and is configured to cooperate in supporting the left and right outer shoes 100. More specifically, the outer shoe subframe 96 defines a pair of tie-rod mounting bores 106 that receive tie-rods from the shoe adjustment assembly 108 for the left and right outer shoes 100, as described in more detail below.

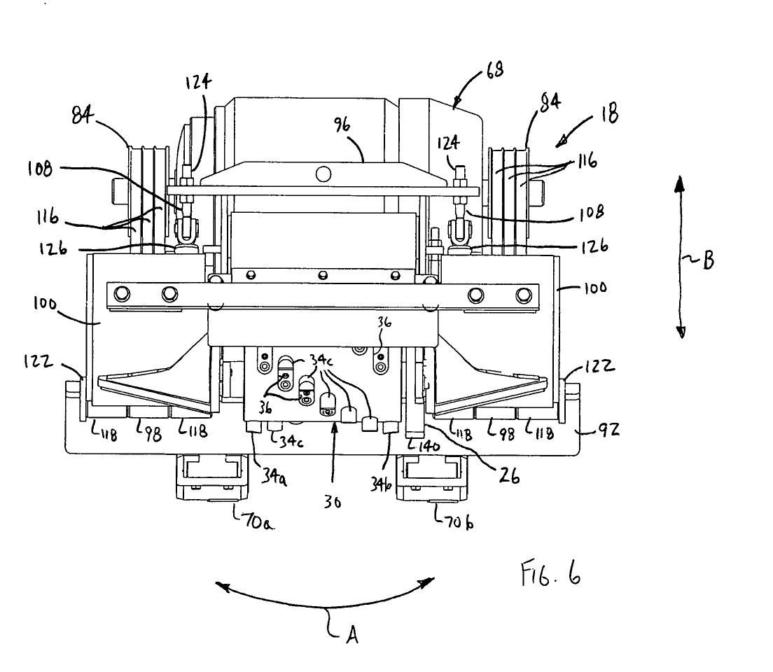

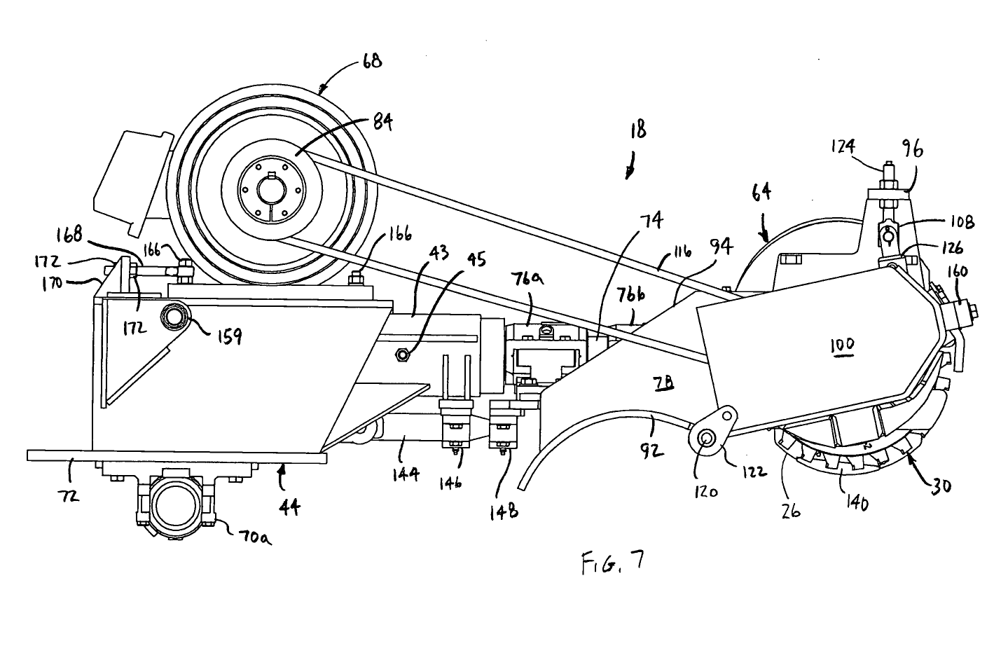

The cutter head arm 18 may also include left and right outer shoes 100 that are mounted to the yoke 64 on opposite sides of the cutter head 30. The outer shoes 100 are configured to ride along the log and help to limit the depth of the cut of cutter head 32. The outer shoes 100 may also be configured to function as shields to house the belt wheels 82. In the illustrated embodiment, the outer shoes 100 are adjustably secured to the yoke 64 by an automated shoe adjustment assembly (not numbered). One end of each outer shoe 100 includes a pair of sleeves 118 that are hingedly intersecured with a corresponding sleeve 98 on the yoke 64 by a hinge pin 120 (See FIG. 7). The hinge pins 120 may be held in place by teardrops 122. The shoe adjustment assembly may include grease fittings (not shown) to permit periodic lubrication of the hinge pins 120. The free end of each outer shoe 100 is coupled to the outer shoe subframe 96 by a tie rod 124 and hydraulic cylinder 126. Actuation of the hydraulic cylinders 126 can be used to raise or lower the free end of the corresponding shoe 100, which causes the shoe 100 to pivot about the hinge pin 120. Accordingly, adjustment of the left and right cylinders 126 varies the position of the outer shoes 100 with respect to the cutter head 30, and thereby adjusts the cutting depth of the cutter head 30. In this illustrated embodiment, the hydraulics for the left and right outer shoes 100 are operatively coupled so that the two outer shoes 100 are raised and lowered together using the same controls. As shown, the outer shoes 100 may be intersecured by cross brace 160. With the illustrated construction, the two outer shoes 100 provide uniform depth control on both sides of the cutter head 30. The outer shoes 100 may be decoupled in applications where independent adjustment of the left and right outer shoes 100 is desired.

As noted above, the cutter head 30 is carried on the yoke 64. The cutter head 30 generally includes an axle 80, a drum 32 and a plurality of cutter teeth 34a-c (See FIGS. 12-15). The cutter head axle 80 is rotationally mounted to cutter head subframe 94 with opposite ends of the axle 80 captured by axle bearings 80a-b, as described above. A plurality of belt wheels 82 are mounted to opposite ends of the cutter head axle 80 (See FIG. 5). As shown, the assembly may include three belt wheels 82 on each end of the cutter head axle 80. The wheels 82 are operatively coupled with corresponding drive wheels 84 mounted to the cutter head drive motor 68. Although shown as belt driven, the cutter head 20 could be driven by essentially any drive mechanism, such as chain or gear drive systems. The cutter head drum 32 is generally cylindrical and is coaxially interconnected with the axle 80. The cutter head drum 32 defines a plurality of cutter tooth slots 36 configured to receive the cutter teeth 34a-c. Referring now to FIG. 15, each of the slots 36 is sized and shaped to closely receive a cutter tooth 34a-c. Each cutter tooth 34a-c is mounted in a cutter tooth slot 36 with the base 40 of the cutter tooth 34a-c closely fitted into the slot 36 and the remainder of the cutter tooth 34a-c exposed. Although the construction of the cutter teeth 34a-c is described in more detail below, it may be helpful to note here that a bolt 42 or other fastener secures each tooth 34a-c to the drum 32. More specifically, in the illustrated embodiment, a bolt 42 extends through a throughbore 86 in the cutter tooth 34a-c into a tapped mounting hole in the drum 32. In use, the close-fitting interface between the base 40 and the slot 36 retains the cutter tooth 34a-c so that the bolt 42 is not required to bear the load of the cutting operation. The depth of the slot 36 may vary from application to application. As shown, the illustrated cutter tooth slots 36 each include a trailing surface 110 and a leading surface 114 that are in direct engagement with opposite ends of the base 40 of the cutter tooth 34a-c. The position and orientation of the trailing surface 110 and the leading surface 114 may vary, but in the illustrated embodiment the trailing and leading surfaces 110 and 114 are configured to support the cutter tooth 34a-c with its blade 112 positioned approximately along a radius of the drum 32. As a result, in this embodiment, the trailing and leading surfaces 110 and 114 extends along a line substantially parallel to a radius of the drum 32, and are spaced apart from the radius approximately the thickness required to put the cutting edge of the blade 112 on the radius. In the illustrated embodiment, the leading surface 114 extends along a line substantially perpendicular to the trailing surface 110. The bottom surface 38 of the slot 36 may extend perpendicularly between the trailing surface 110 and the leading surface 114 as perhaps best shown in FIG. 15. The design and orientation of the leading surface 114, the trailing surface 110 and the bottom surface 38 may vary from application to application, as desired.

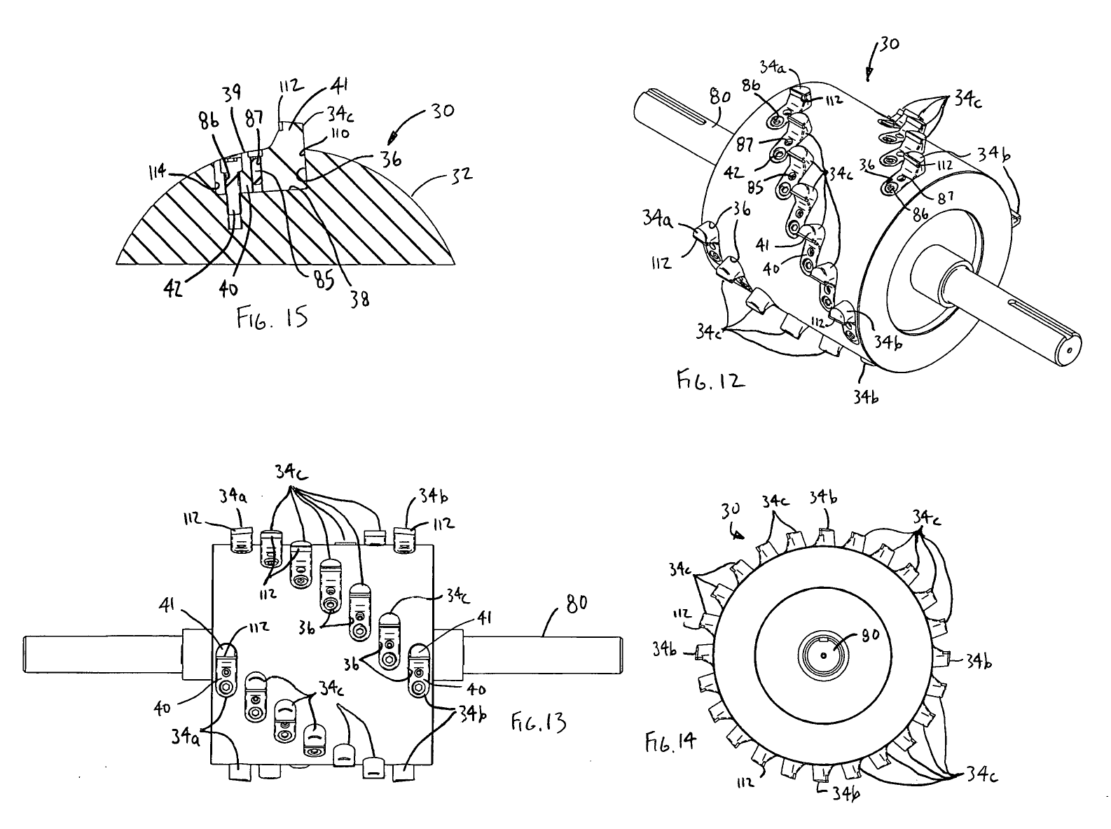

As noted above, the cutter teeth 34a-c of the illustrated embodiment generally include a base 40 and a finger 41. Although three slightly different cutter teeth are included in the illustrated embodiment, the general configuration of the cutter teeth 34a-c will be described with reference to FIGS. 16A-B and 17, which show a straight cutter tooth. The left and right cutter teeth 34a and 34b are shown in FIGS. 18 and 19 with similar components being identified by identical reference numerals. The base 40 is configured to correspond in shape with the cutter tooth slots 36 so that the cutter head drum 32 (rather than the mounting bolt 42) will bear the load of the cutting operation. The finger 41 extends from the base 40 and provides structure for supporting the cutter tooth blade 112, as described in more detail below. Although the cutter teeth may vary in shape, the cutter teeth 34a-c of the illustrated embodiment are generally L-shaped with the base 40 forming one leg of the “L” and the finger 41 forming the other leg (See FIG. 16A. The mounting throughbore 86 extends through the base 40 in a direction substantially perpendicular to the bottom surface 38 of the slot 36. The top surface 39 of the base 40 may be curved to follow the shape of the cutter head drum 32. The mounting throughbore 86 may be counter-bore to receive the head of the bolt 42. The cutter teeth 34a-c may also define a second throughbore 87 to receive a component to assist in removing the cutter teeth 34a-c for repair or replacement (See FIG. 15). In the illustrated embodiment, the removal throughbore 87 extends through the base 40 in a direction substantially parallel to the mounting throughbore 86. The interior surface of the removal throughbore 87 may be threaded to interact with an externally threaded removal component, such as a removal stud 85 or removal bolt (not shown). The removal throughbore 87 may be counter-bore to recess the stud 85 or the head of a removal bolt (not shown). The removal stud 85 may be installed in the cutter tooth 34a-c before, during or after installation of the cutter tooth 34a-c on the drum 32. For example, the stud 85 can be threaded into the removal throughbore 87 until it is approximately in the position shown in FIG. 15. When it is desirable to remove the cutter tooth 34a-c, the mounting bolt 42 can be removed and the removal stud 85 can be rotated further into the removal throughbore 87 eventually interacting with the bottom surface 38 of the slot 36 to drive the cutter tooth 34a-c out of the slot 36. The size, shape configuration and location of the removal throughbore 86 and removal stud 85 may vary from application to application.

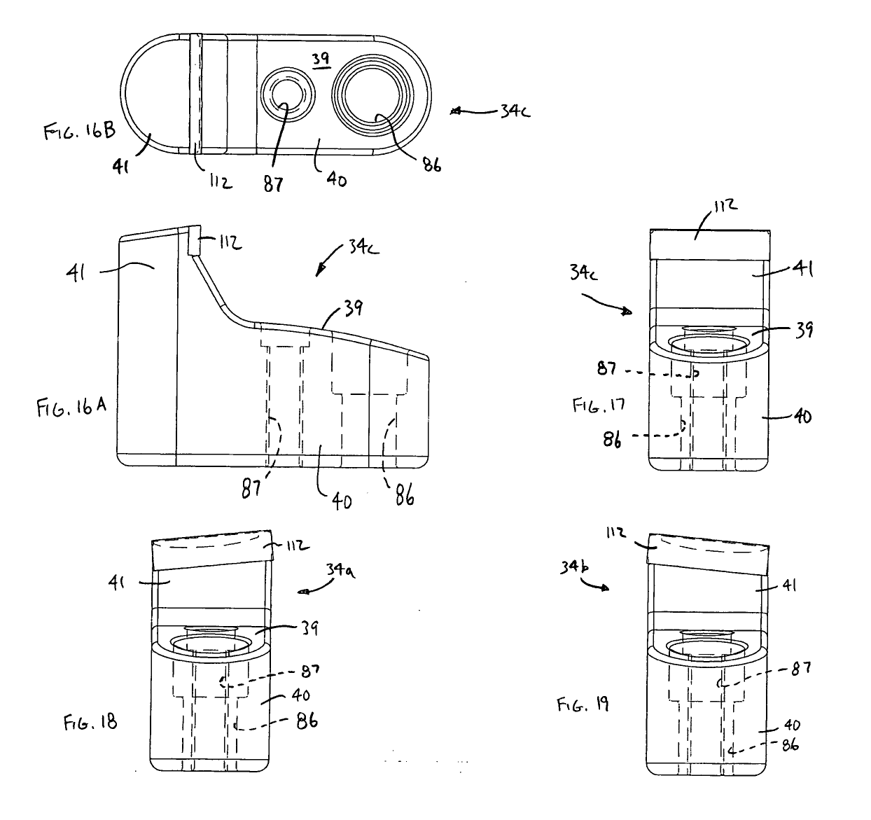

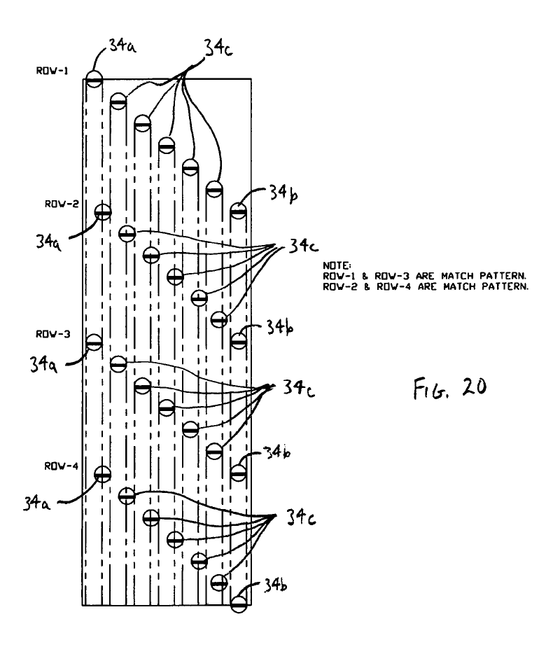

In the illustrated embodiment, the cutter head 30 includes three different types of cutter teeth 34a-c, namely left-hand teeth 34a (FIG. 18), right-hand teeth 34b (FIG. 19) and straight teeth 34c (FIGS. 16A-B and 17). As shown in FIGS. 13 and 20, the left-hand teeth 34a are mounted at the left-hand end of the drum 32, right-hand teeth 34b are mounted at the right-hand end of the drum 32 and straight teeth 34c are mounted in the center region of the drum 32. Each cutter tooth 34a-c includes a blade 112, though the angle of the cutting edge of the blade 112 varies depending on the type of tooth 34a-c. With both left-hand teeth 34a and right-hand teeth 34b, the cutting edge of the blade 112 is angled downwardly toward the outside of the drum 32. With straight teeth 34c, the cutting edge of the blade 112 is essentially parallel to the surface of the drum 32. The angled left-hand teeth 34a and right-hand teeth 34b function as the leading edge of the cutter head 30 when the carriage 22 is moved in the corresponding direction. The angled blades 112 facilitate clean and efficient operation of the cutting head 30 when it is in longitudinal motion. The blades 112 may be removably mounted to the outer end of the teeth 34, for example, by screws or bolts (not shown).

The position of the cutter teeth 34a-c on the drum 32 may vary. However, in the illustrated embodiment, the cutter teeth 34a-c are arranged around the drum 32 in a plurality of spiral paths. In the illustrated embodiment, the cutter head 30 includes four spiral rows of cutter teeth 34a-c with each row extending around about ¼ of the circumference of the drum 32. Each row includes a string of straight cutter teeth 34c with a single right-hand tooth 34b on the right-hand end and a single left-hand tooth 34a on the left-hand end. The cutter teeth 34a-c are spaced along the drum 32 so that in at least some locations, one or more teeth 34a-c of one row overlap the corresponding teeth 34a-c of at least one adjacent row. The degree of overlap may vary from application to application depending on the length of the drum 32, the number of teeth 34a-c in each row and the width of each tooth 34a-c. In the illustrated embodiment, the teeth 34a-c overlap by as much as approximately 50% in some locations. A flat pattern showing the location of the teeth 34a-c along the drum 32 is shown in FIG. 20. The cutter teeth 34a-c placement shown in FIG. 20 is merely exemplary, and the cutter teeth placement may vary from application to application as desired. If desired, the right-hand teeth 34a and/or the left-hand teeth 34b may be aligned from row to row (rather than overlapping) so that all four rows of teeth start and stop at approximately the same longitudinal position along the drum 32.

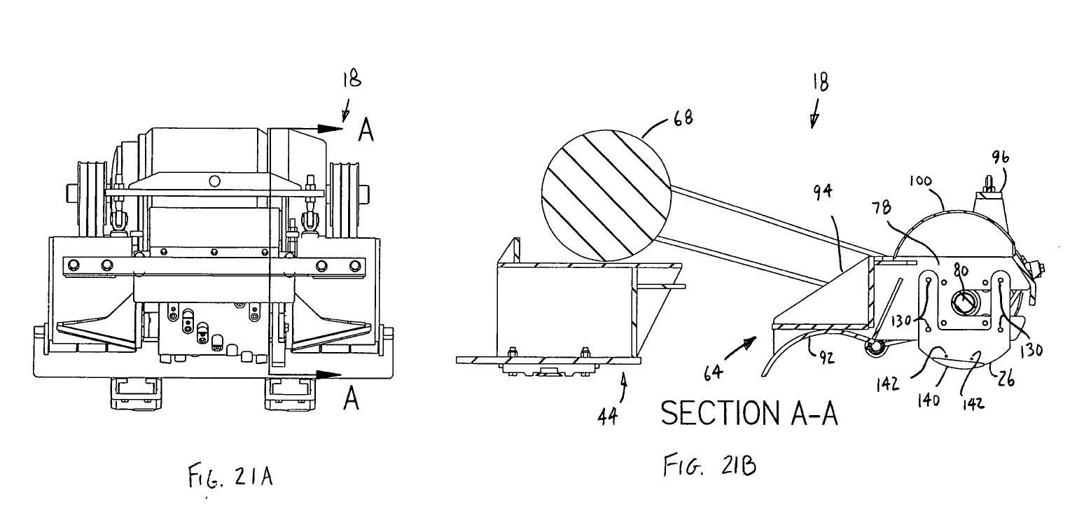

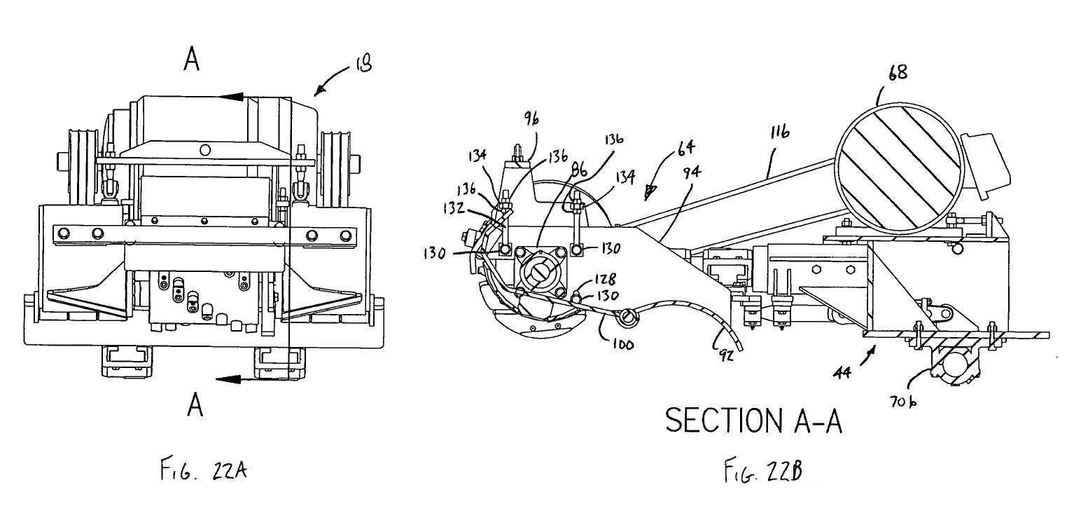

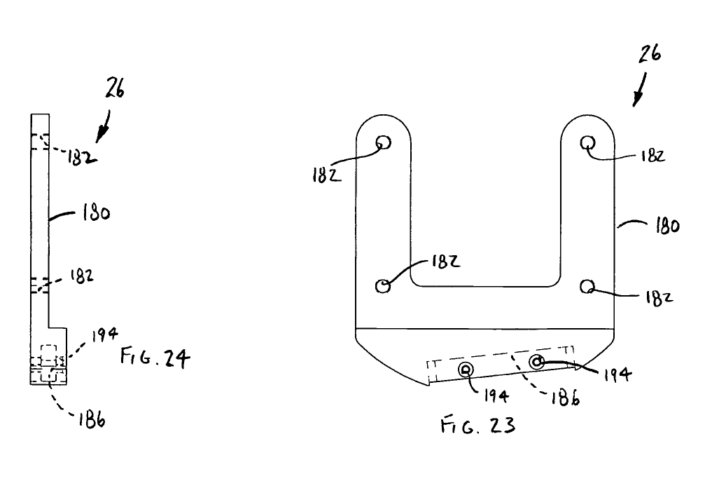

It is common to use a debarker to reduce the thickness of the butt end of a log. To facilitate butt end reducing operations, it is conventional practice to supply logs to a debarker with all of the butt ends pointing in the same direction. The present invention is described in connection with a debarker in which the logs are to be fed into the debarker with the butt ends pointing to the left (with respect to FIG. 6). The terms “trailing” and “leading” are used as expedients to refer to directions dictated by motion of the cutter head and would vary depending on the orientation of the logs. The term “leading” refers to a direction toward the butt end of the log (in the illustrated embodiment, to the left) and the term “trailing” refers to the opposite direction. For example, in the illustrated embodiment, the left end of the cutter head is the “leading” end because it will be leading the cutter head 30 when the cutter head 30 is moving down the log toward the butt end. In one embodiment, the present invention includes a manually adjustable shoe 26 to support the trailing end of the cutter head 30 (See FIG. 6) independently of the outer shoes 100. As noted above, the outer shoes 100 are moved in unison to set the right and left ends of the cutter head 30 at the same cutting depth. As a result of their coupled movement, the manually adjustable shoe 26 provides advantages over the outer shoes 100 in some applications. For example, the adjustable shoe 26 provides supplemental depth control that permits the trailing end of the cutter head 30 to be shoed at a lesser depth than the leading end. This is particularly useful when performing butt reducing operations. When the cutter head 30 extends off the end of a log, the manually adjustable shoe 26 remains on the log to support and control the cutting depth of the cutter head 30. In the illustrated embodiment, the manually adjustable shoe 26 includes a generally U-shaped main body 180 (See FIGS. 23 and 24). The main body 180 defines four mounting holes 182 for mounting the shoe 26 using screws 184 or other fasteners. The adjustable shoe 26 may include a wear insert 140 as shown in FIGS. 25 and 26. In the illustrated embodiment, the wear insert 140 includes a head 188 and a mounting flange 190. The mounting flange 190 defines a pair of mounting holes 192 for use in securing the wear insert 140 to the main body 180. The main body 180 may define a channel 186 configured to receive the mounting flange 190, and a pair of mounting holes 194 that align with the mounting holes 192 in the mounting flange. The mounting holes 194 on one side of the channel 186 may be tapped to receive mounting screws 184. In the illustrated embodiment, the manually adjustable shoe 26 is mounted to the cutter head subframe 94, and more specifically to the mounting wall 78 on the trailing end of the cutter head. As perhaps best shown in FIG. 10, the mounting wall 78 defines a plurality of mounting slots 128. Referring now to FIG. 21B, the adjustable shoe 26 is secured to the mounting wall 78 by fasteners 130, such as bolts 184, extending through the mounting holes 182 in the main body 180 and the mounting slots 128 in the mounting wall 78. The upper two fasteners 130 extend into the eyes on eyebolts 132 on the opposite side of the mounting wall 78. The eyebolts 132 are secured to flanges 134 on the outer shoe subframe 96 by adjustment nuts 136. The position of the adjustable shoe 26 can be easily manually adjusted by moving the adjustment nuts up or down the eyebolts 132. The lower two fasteners 130 extend through the bottom mounting slots 128 and are threadedly secured by washers and lock nuts 138. The lock nuts 138 are left at least somewhat loose so that the fasteners 130 can travel within the slots 128 as dictated by the position of adjustment nuts 136 along the eyebolts 132.

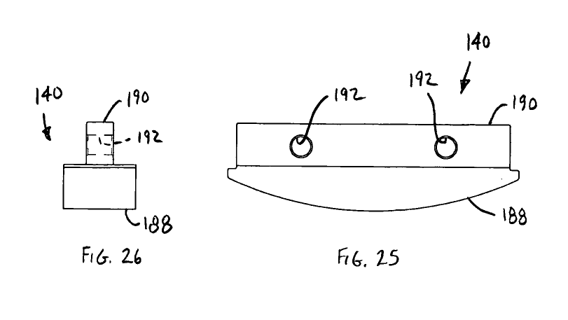

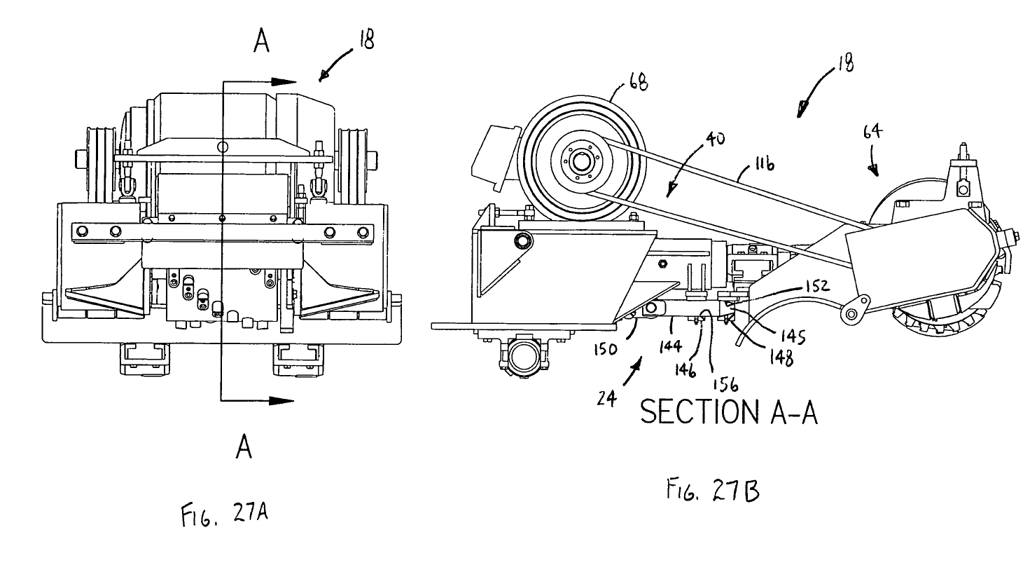

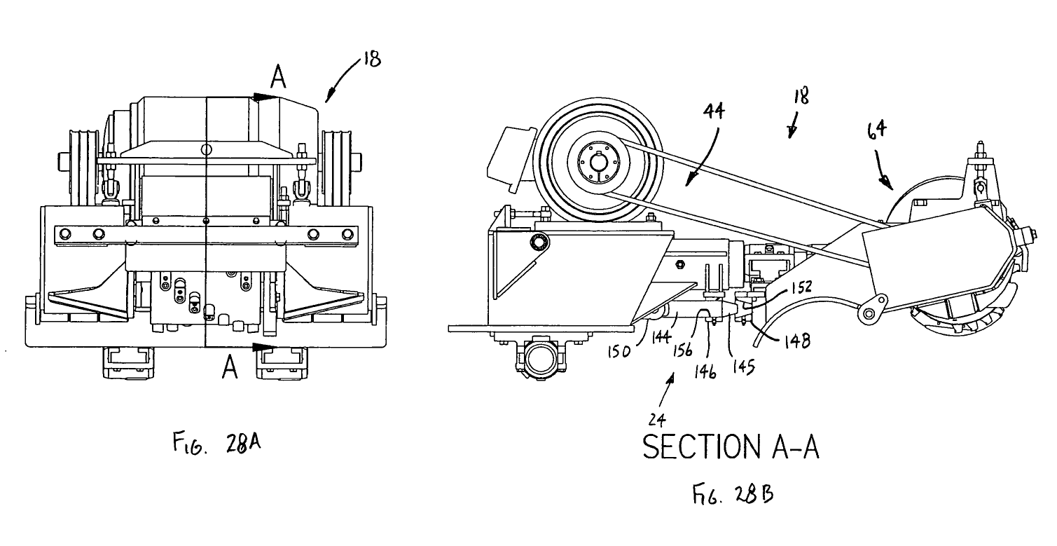

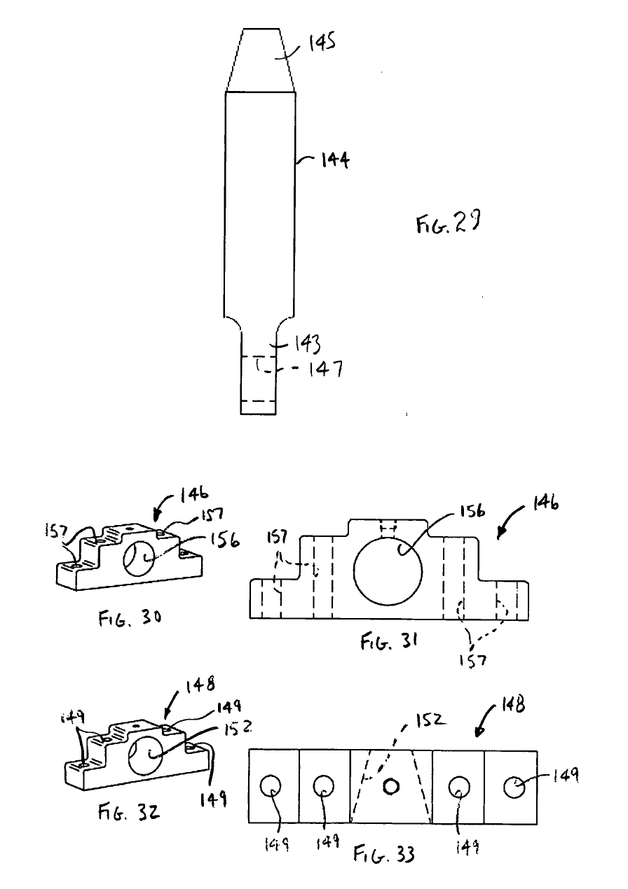

The debarker 10 may also include a yoke pivot lock 24 that permits the operator to selectively lock the yoke 64 against axial deflection (See FIGS. 27B and 28B). The yoke pivot lock 24 generally includes a locking pin 144, a guide 146, a receiver 148 and a hydraulic cylinder 150 for operating the yoke pivot lock 24. The hydraulic cylinder 150 is mounted to the cutter arm frame 44, for example, at mounting ear 151. The locking pin 144 is generally cylindrical and includes a base 143 and a tip 145. The base 143 defines a mounting hole 147. The locking pin 144 is fixed to the rod of cylinder 150, for example, by a bolt (not shown) extending through the mounting hole 147. Accordingly, operation of cylinder 150 results in linear movement of the locking pin 144. The guide 146 provides a mechanism for shepherding the locking pin 144 throughout its range of linear motion. The guide 146 defines a central bore 156 that slidably receives the locking pin 144. The guide 146 also defines a plurality of mounting holes 157 for mounting the guide 146 to the cutter arm frame 44. The receiver 148 is mounted to the yoke 64 and becomes engaged with the locking pin 144 when the pivot lock cylinder 150 is in the extended position (See FIG. 27B). The receiver 148 defines a plurality of mounting holes 149 for mounting the receiver 148 to the yoke 64. The receiver 148 also defines a central opening 152 adapted to receive the free end of the locking pin 144 when the hydraulic cylinder 150 is in the extended (or locked) position. To facilitate engagement of the yoke pivot lock 24, yoke pivot lock 24 may include an alignment mechanism that draws the yoke 64 into a centered position. In this illustrated embodiment, the yoke 64 is brought to the centered position automatically as the locking pin 144 is extended as a result of the shape of the outer end of the locking pin 144 and the opening 152 in the receiver 148. More specifically, in the illustrated embodiment, the outer end 145 of the locking pin 144 and the opening 152 are cone shaped. The cone-shaped tip 145 of the locking pin 144 will engage the opening 152 in the receiver 148 even when the cutter head 30 is substantially deflected (See FIG. 28B). As the locking pin 144 continues to extend the two cone-shaped surfaces will interact to pull the yoke 64 back into the centered position (See FIG. 27B).

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A debarker comprising:
a frame;
a yoke pivotally mounted to said frame;
a cutter head assembly operatively supported by said yoke, whereby said cutter head assembly is capable of pivotal movement with respect to said frame via pivotal movement of said yoke with respect to said frame; and
a yoke pivot lock mounted to at least one of said frame and said yoke, said yoke pivot lock selectively operable between an unlocked position in which said yoke is capable of pivotal movement with respect to said frame and a locked position in which said yoke is incapable of pivotal movement with respect to said frame.

2. The debarker of claim 1 wherein said yoke pivot lock includes a locking pin and a receiver, said locking pin and said receiver being engaged when said yoke pivot lock is in said locked position, said locking pin and said receiver being disengaged when said yoke pivot lock is in said unlocked position.

3. The debarker of claim 2 wherein said locking pin includes a cone-shaped tip.

4. The debarker of claim 2 wherein said receiver defines a cone-shaped opening.

5. The debarker of claim 2 wherein said locking pin includes a cone-shaped tip and said receiver defines a cone-shaped opening.

6. The debarker of claim 2 further including an actuator coupled to said locking pin to move said locking pin linearly with respect to said receiver.

7. A cutter head for a debarker comprising:
a drum defining a plurality of cutter tooth slots; and
a plurality of cutter teeth, each of said cutter teeth having a base and a finger, each of said cutter teeth being mounted in a corresponding one of said cutter tooth slots, each of said slots defining a recess, said base of each of said cutter teeth being closely fitted into said recess of said corresponding cutter tooth slot; said finger of said cutter teeth being exposed outside of said recess to support a blade extending in a generally radial direction; each of said cutter teeth being secured to said drum by a fastener, each of said fasteners extending through said base of said cutter tooth.

8. The cutter head of claim 7 wherein said cutter teeth further includes a removal component, said removal component being selectively operable to drive said cutter tooth from said slot.

9. The cutter head of claim 8 wherein said base defines a removal throughbore, said removal throughbore being internally threaded; and
wherein said removal component is externally threaded and fitted within said removal throughbore, said removal component being selectively movable with respect to said removal throughbore to engage said drum and selectively drive said cutter tooth form said slot.

10. The cutter head of claim 9 wherein each of said cutter teeth is generally L-shaped with first and second legs, said base forming said first leg and said finger forming said second leg, said mounting throughbore and said removal throughbore extending through said base.

11. The cutter head of claim 10 wherein said removal component is further defined as a threaded stud and said mounting throughbore hole is counter-bore.

12. A debarker comprising:
a frame;
a cutter head assembly pivotally mounted to said frame, said cutter head assembly having a leading end and a trailing end;
a pair of primary shoes disposed on opposite sides of said cutter head; and
a supplemental shoe mounted to said cutter head assembly on said trailing end, said supplemental shoe being adjustable with respect to said cutter head.

13. The debarker of claim 12 wherein said frame includes a pair of spaced apart mounting plates, opposite sides of said cutter head being pivotally mounted to said spaced apart mounting plates; said supplemental shoe being mounting to one of said mounting plates.

14. The debarker of claim 13 wherein said supplemental shoe includes a removable wear insert.

15. The debarker of claim 14 further including a primary shoe adjustment mechanism, said primary shoe adjustment mechanism simultaneously adjusting both of said primary shoes, said adjustment mechanism adjusting said primary shoes independently of said supplemental shoe.

16. The debarker of claim 12 wherein said frame includes a pivotable yoke, said cutter head assembly mounted to said yoke, whereby said cutter head assembly is capable of pivotal movement with respect to said frame via pivotal movement of said yoke; and
a yoke pivot lock mounted to at least one of said frame and said yoke, said yoke pivot lock selectively operable between an unlocked position in which said yoke is capable of pivotal movement with respect to said frame and a locked position in which said yoke is incapable of pivotal movement with respect to said frame.

17. The debarker of claim 16 wherein said yoke includes a pair of mounting plates, said cutter head assembly being rotatably mounted between said plates, said supplemental shoe adjustably mounted to one of said mounting plates.

18. A cutter head for a debarker comprising:
a drum; and
a plurality of cutter teeth mounted to said drum, said cutter teeth being arranged on said drum in a plurality of cutter teeth rows, said cutter teeth rows extending in a generally longitudinal direction across said drum, said cutter teeth being arranged such that at least a plurality of teeth in a first row overlap to a substantial degree with a corresponding plurality of cutter teeth in a second row.

19. The cutter head of claim 18 wherein said cutter teeth have a width, said plurality of overlapping teeth overlap by at least one-fourth of said width of said cutter teeth.

20. The cutter head of claim 19 wherein at least one of said plurality of cutter teeth said first row are substantially aligned with a corresponding one of said plurality of cutter teeth in said second row.
